(19) United States
(12) Patent Application Publication
(10) Pub. No.: US 2023/0180283 A1
(43) Pub. Date: Jun. 8, 2023

(54) Methods For Intra-User Equipment Prioritization In Wireless Communications

(71) Applicant: MediaTek Singapore Pte. Ltd., Singapore (SG)

(72) Inventors: Mohammed S Aleabe Al-Imari, Cambridge (GB); Abdellatif Salah, Cambridge (GB); Jozsef Gabor Nemeth, Cambridge (GB)

(21) Appl. No.: 17/922,528

(22) PCT Filed: May 8, 2021
(86) PCT No.: PCT/CN2021/092282

§ 371 Date: Oct. 31, 2022

Related U.S. Application Data
(60) Provisional application No. 63/023,901, filed on May 13, 2020.

(51) Int. Cl. H04W 72/566; H04W 72/1268

(52) U.S. Cl. CPC H04W 72/569; H04W 72/1268

(57) ABSTRACT

Various solutions for intra-user equipment (UE) prioritization in wireless communications are described. An apparatus (e.g., a UE) detects a scheduling of a high-priority transmission. The apparatus then determines whether the high-priority transmission overlaps with a low-priority transmission. In response to determining that the high-priority transmission overlaps with the low-priority transmission, the apparatus determines to ignore a scheduling of the low-priority transmission when a scheduling of the low-priority transmission is detected.

### CROSS REFERENCE TO RELATED PATENT APPLICATION(S)

The present disclosure is part of U.S. National Stage filing of International Patent Application No. PCT/CN2021/092282, filed on 08 May 2021, which is part of a non-provisional application claiming the priority benefit of U.S. Patent Application No. 63/023,901, filed on 13 May 2020, the contents of which being incorporated by reference in their entirety.

### TECHNICAL FIELD

The present disclosure is generally related to mobile communications and, more particularly, to intra-user equipment (UE) prioritization in wireless communications.

### BACKGROUND

Unless otherwise indicated herein, approaches described in this section are not prior art to the claims listed below and are not admitted as prior art by inclusion in this section.

In wireless communications, such as mobile communications based on the 3^{rd} Generation Partnership Project (3GPP) specification(s) for 5^{th} Generation (5G) New Radio (NR) and beyond, the priority of physical uplink shared channel (PUSCH) transmission without scheduling downlink control information (DCI) is determined by a high-layer radio resource control (RRC) parameter such as the phy-PriorityIndex in ConfiguredGrantConfig. The priority of dynamic-grant PUSCH (DG-PUSCH) is determined by a bit in the DCI. In DCI format 0_1, the priority indicator bit is set to “0” if the higher-layer parameter PriorityIndicator-ForDCIFormat0_1 is not configured; otherwise, the priority indicator bit is set to “1”. In DCI format 0_2, the priority indicator bit is set to “0” if the higher-layer parameter PriorityIndicator-ForDCIFormat0_2 is not configured; otherwise, the priority indicator bit is set to “1”. On the other hand, with respect to configured-grant PUSCH (CG-PUSCH), the priority of initial transmission of the CG-PUSCH is determined by the RRC parameter. However, there remains issues to be addressed as to how to determine the priority of a retransmission of a CG-PUSCH.

Similarly, in wireless communications, such as mobile communications based on the 3GPP specification(s) for 5G NR and beyond, the priority of hybrid automatic repeat request (HARQ) feedback for semi-persistent scheduling physical downlink shared channel (SPS-PDSCH) transmission without scheduling DCI is determined by a high-layer RRC parameter such as the harq-CodebookID in SPS-Config. The priority of HARQ feedback for dynamically scheduled PDSCH is determined by a bit in the DCI. In DCI format 1_1, the priority indicator bit is set to “0” if the higher-layer parameter PriorityIndicator-ForDCIFormat1_1 is not configured; otherwise, the priority indicator bit is set to “1”. In DCI format 1_2, the priority indicator bit is set to “0” if the higher-layer parameter PriorityIndicator-ForDCIFormat1_2 is not configured; otherwise, the priority indicator bit is set to “1”. However, there remains issues to be addressed as to how to determine the priority of the HARQ feedback for a retransmission of an SPS-PDSCH.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure are believed to address issues pertaining to intra-UE prioritization in wireless communications.

In one aspect, a method may involve detecting a scheduling of a high-priority transmission. The method may also involve determining whether the high-priority transmission overlaps with a low-priority transmission. The method may further involve determining to ignore a scheduling of the low-priority transmission, in an event that a scheduling of the low-priority transmission is detected, responsive to determining that the high-priority transmission overlaps with the low-priority transmission.

In another aspect, a method may involve performing a CG-PUSCH initial transmission to a wireless network. The method may also involve determining a priority based on one or more signals from the wireless network. The method may further involve performing a CG-PUSCH retransmission to the wireless network with the determined priority.

In yet another aspect, a method may involve performing a SPS-PDSCH initial transmission to a wireless network. The method may also involve determining a priority based on one or more signals from the wireless network. The method may further involve performing a SPS-PDSCH retransmission to the wireless network with the determined priority.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT) and non-terrestrial network (NTN) communications, the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication apparatus and an example network apparatus in accordance with an implementation of the present disclosure.

FIG. 3 is a flowchart of an example process in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to intra-UE prioritization in wireless communications. According to the present disclosure, a number of possible solutions may be implemented separately or jointly. That is, although these possible solutions may be described below separately, two or more of these possible solutions may be implemented in one combination or another.

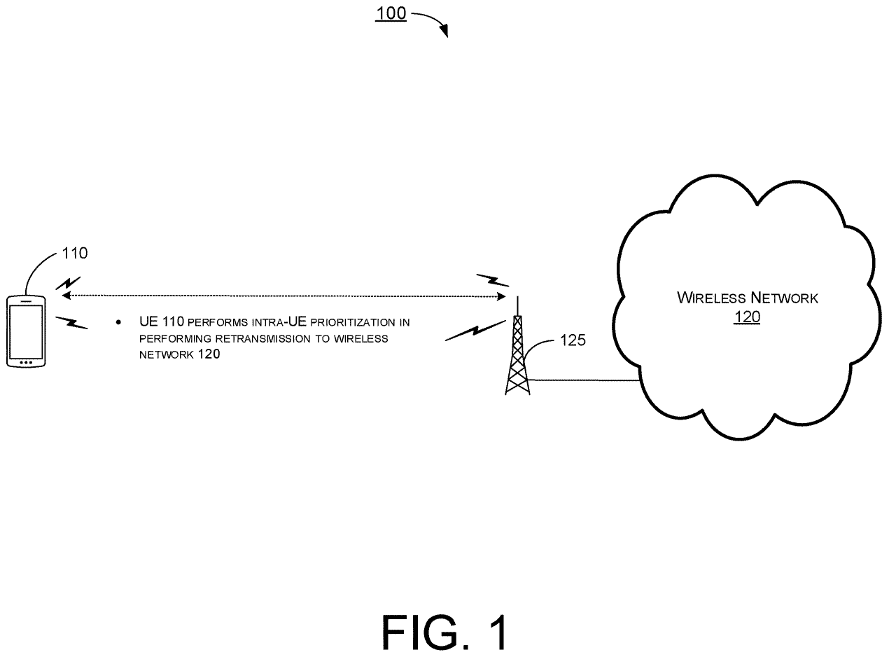

FIG. 1 illustrates an example network environment 100 in which various solutions and schemes in accordance with the present disclosure may be implemented. Referring to FIG. 1, network environment 100 may involve a UE 110 in wireless communication with a wireless network 120 (e.g., a 5G NR mobile network or another type of network such as an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to intra-UE prioritization in wireless communications, as described below.

Under a first proposed scheme in accordance with the present disclosure with respect to CG-PUSCH priority, in case the priority indicator is not configured in any of the uplink (UL) scheduling DCIs, the priority of a retransmission of a CG-PUSCH may follow the priority of an initial transmission of the same CG configuration. Under the proposed scheme, in an event that the priority indicator is not configured in any of the UL scheduling DCIs, the priority of the retransmission of a CG-PUSCH may be determined by the RRC parameter phy-PriorityIndex in ConfiguredGrantConfig. For instance, the priority of the retransmission of a CG-PUSCH may be determined by the RRC parameter phy-PriorityIndex in ConfiguredGrantConfig in case the retransmission is scheduled by DCI format 0_1 or DCI format 0_2. Otherwise, the priority of the retransmission of a CG-PUSCH may be considered low in case the retransmission is scheduled by DCI format 0_0. Under the proposed scheme, in an event that UE 110 is configured with multiple active configured-grant (CG) configurations, UE 110 may select the configured priority (phy-PriorityIndex) from the CG configuration associated with the retransmission of CG-PUSCH.

Under a second proposed scheme in accordance with the present disclosure with respect to CG-PUSCH priority, in case the priority indicator is not configured in any of the UL scheduling DCIs, the priority of a retransmission of a CG-PUSCH may be treated as low priority regardless of the priority configured in the CG configuration. For instance, in case the priority indicator is not configured in any of the UL scheduling DCIs, the priority of the retransmission of a CG-PUSCH may be treated as low priority regardless of the RRC parameter phy-Prioritylndex in ConfiguredGrantConfig.

Under a third proposed scheme in accordance with the present disclosure with respect to CG-PUSCH priority, for UE 110 that is configured with DCI format 0_1 and DCI format 0_2, in an event that the priority indicator is not configured in both DCI format 0_1 and DCI format 0_2, the priority of the retransmission of a CG-PUSCH may be determined differently depending on whether the scheduling DCI is configured with a priority indicator. Under the proposed scheme, in case the retransmission of a CG-PUSCH is scheduled with a DCI that is not configured with a priority indicator, the priority of the retransmission of the CG-PUSCH may follow the priority of the initial transmission of the same CG configuration. For instance, in case the retransmission of a CG-PUSCH is scheduled with a DCI that is not configured with a priority indicator, the priority of the retransmission of the CG-PUSCH may be determined by the RRC parameter phy-Prioritylndex in ConfiguredGrantConfig. Moreover, the priority of the retransmission of a CG-PUSCH may be considered low in an event that the retransmission is scheduled by DCI format 0_0. Under the proposed scheme, in case the retransmission of a CG-PUSCH is scheduled with a DCI that is configured with a priority indicator, the priority of the retransmission of the CG-PUSCH may follow the priority indicated in the DCI.

Under a fourth proposed scheme in accordance with the present disclosure with respect to CG-PUSCH priority, in an event that UE 110 is not configured with a priority indicator in any of the UL scheduling DCIs, UE 110 may not expect to be configured with phy-Prioritylndex in ConfiguredGrantConfig.

Under a first proposed scheme in accordance with the present disclosure with respect to the priority of HARQ for SPS-PDSCH, in case the priority indicator is not configured in any of the downlink (DL) scheduling DCIs, the priority of a HARQ feedback for a retransmission of an SPS-PDSCH may follow the priority of an initial transmission of the same SPS configuration. Under the proposed scheme, in an event that the priority indicator is not configured in any of the DL scheduling DCIs, the priority of the HARQ feedback for a retransmission of an SPS-PDSCH may be determined by the RRC parameter harq-CodebookID in the SPS PDSCH configuration. For instance, the priority of the HARQ feedback for a retransmission of an SPS-PDSCH may be determined by the RRC parameter harq-CodebookID in the SPS PDSCH configuration in case the retransmission is scheduled by DCI format 1_1 or DCI format 1_2. Otherwise, the priority of the retransmission of the SPS-PDSCH may be considered low in case the retransmission is scheduled by DCI format 1_0. Under the proposed scheme, in an event that UE 110 is configured with multiple active SPS configurations, UE 110 may select the configured priority (harq-CodebookID) from the SPS configuration associated with the retransmission of SPS-PDSCH.

Under a second proposed scheme in accordance with the present disclosure with respect to the priority of HARQ for SPS-PDSCH, in case the priority indicator is not configured in any of the DL scheduling DCIs, the priority of the HARQ feedback for a retransmission of an SPS-PDSCH may be treated as low priority regardless of the priority configured in the SPS configuration. For instance, in case the priority indicator is not configured in any of the DL scheduling DCIs, the priority of the HARQ feedback for a retransmission of an SPS-PDSCH may be treated as low priority regardless of the RRC parameter harq-CodebookID in the SPS PDSCH configuration.

Under a third proposed scheme in accordance with the present disclosure with respect to the priority of HARQ for SPS-PDSCH, for UE 110 that is configured with DCI format 1_1 and DCI format 1_2, in an event that the priority indicator is not configured in both DCI format 1_1 and DCI format 1_2, the priority of the HARQ feedback for a retransmission of an SPS-PDSCH may be determined differently depending on whether the scheduling DCI is configured with a priority indicator. Under the proposed scheme, in case the retransmission of an SPS-PDSCH is scheduled with a DCI that is not configured with a priority indicator, the priority of the HARQ feedback for the retransmission of the SPS-PDSCH may follow the priority of the initial transmission of the same SPS configuration. For instance, in case the retransmission of an SPS-PDSCH is scheduled with a DCI that is not configured with a priority indicator, the priority of the HARQ feedback for the retransmission of the SPS-PDSCH may be determined by the RRC parameter harq-CodebookID in the SPS PDSCH configuration. Moreover, the priority of the HARQ feedback for the retransmission of an SPS-PDSCH may be considered low in case the retransmission is scheduled by DCI format 1_0. Under the proposed scheme, in case the retransmission of an SPS-PDSCH is scheduled with a DCI that is configured with a priority indicator, the priority of the HARQ feedback for a retransmission of the SPS-PDSCH may follow the priority indicated in the DCI.

Under a fourth proposed scheme in accordance with the present disclosure with respect to the priority of HARQ for SPS-PDSCH, in an event that UE 110 is not configured with a priority indicator in any of the DL scheduling DCIs, UE 110 may not expect to be configured with two HARQ acknowledgement (HARQ-ACK) codebooks.

Under a first proposed scheme in accordance with the present disclosure with respect to intra-UE prioritization order, in case a physical downlink control channel (PDCCH) for a low-priority DG-PUSCH is not before a PDCCH for a high-priority DG-PUSCH, UE 110 may not expect to be scheduled with the low-priority DG-PUSCH that collides or otherwise overlaps with the high-priority DG-PUSCH. For instance, UE 110 may not expect to be scheduled with a low-priority DG-PUSCH that collides or otherwise overlaps with a high-priority DG-PUSCH in case the last symbol of the PDCCH for the low-priority DG-PUSCH is not before the last symbol of the PDCCH for the high-priority DG-PUSCH. Accordingly, in an event that UE 110 receives scheduling for a low-priority DG-PUSCH after UE 110 has determined that the last symbol of a PDCCH for the low-priority DG-PUSCH is not before the last symbol of a PDCCH for a high-priority DG-PUSCH, UE 110 may determine that the low-priority DG-PUSCH would collide or otherwise overlap with the high-priority DG-PUSCH and thus UE 110 may ignore the scheduling for the low-priority DG-PUSCH. In other words, upon detecting a first DCI scheduling a high-priority DG-PUSCH transmission that would collide or otherwise overlap with a low-priority DG-PUSCH transmission, UE 110 may not expect to perform (and may ignore performing) the low-priority DG-PUSCH transmission due to detection of a second DCI scheduling the low-priority DG-PUSCH transmission after detection of the first DCI.

Under a second proposed scheme in accordance with the present disclosure with respect to intra-UE prioritization order, in case a PDCCH for a low-priority physical uplink control channel (PUCCH) is not before a PDCCH for a high-priority PUCCH, UE 110 may not expect to be scheduled with the low-priority PUCCH that collides or otherwise overlaps with the high-priority PUCCH. For instance, UE 110 may not expect to be scheduled with a low-priority PUCCH that collides or otherwise overlaps with a high-priority PUCCH in case the last symbol of the PDCCH for the low-priority PUCCH is not before the last symbol of the PDCCH for the high-priority PUCCH. Accordingly, in an event that UE 110 receives scheduling for a low-priority PUCCH after UE 110 has determined that the last symbol of a PDCCH for the low-priority PUCCH is not before the last symbol of a PDCCH for a high-priority PUCCH, UE 110 may determine that the low-priority PUCCH would collide or otherwise overlap with the high-priority PUCCH and thus UE 110 may ignore the scheduling for the low-priority PUCCH. In other words, upon detecting a first DCI scheduling a high-priority PUCCH transmission that would collide or otherwise overlap with a low-priority PUCCH transmission, UE 110 may not expect to perform (and may ignore performing) the low-priority PUCCH transmission due to detection of a second DCI scheduling the low-priority PUCCH transmission after detection of the first DCI.

### Illustrative Implementations

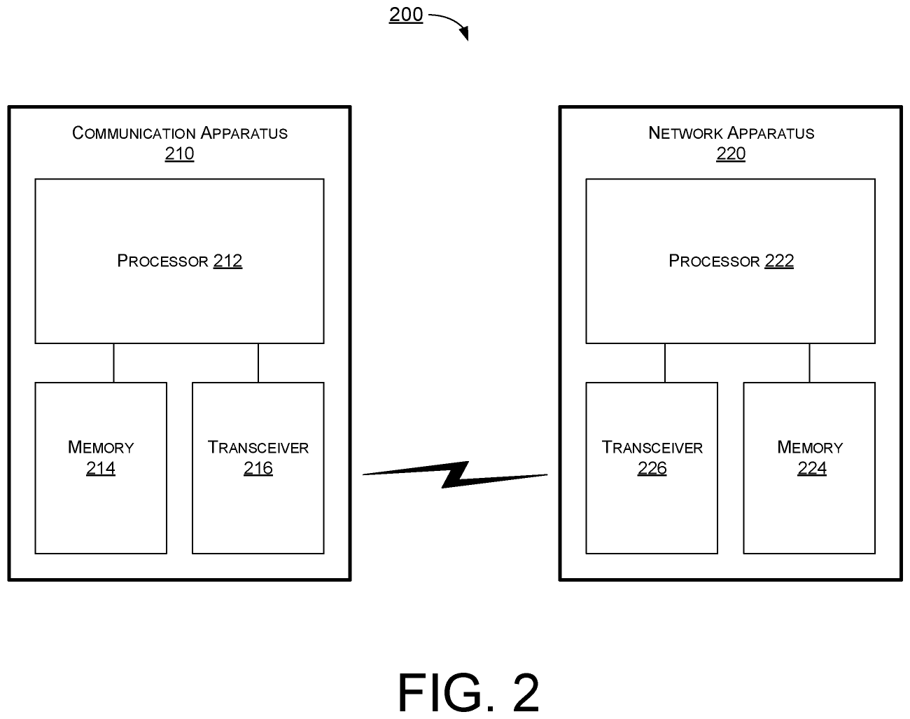

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to intra-UE prioritization in wireless communications, including scenarios/schemes described above as well as processes 300, 400 and 500 described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including power consumption reduction in a device (e.g., as represented by communication apparatus 210) and a network (e.g., as represented by network apparatus 220) in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., network node 125) of a communication network (e.g., wireless network 120). It is also noteworthy that, although the example implementations described below are provided in the context of mobile communications, the same may be implemented in other types of networks.

Under a proposed scheme pertaining to intra-UE prioritization in wireless communications in accordance with the present disclosure, with communication apparatus 210 implemented in or as UE 110 and network apparatus 220 implemented in or as network node 125 in network environment 100, processor 212 of communication apparatus 210 may detect, via transceiver 216, a scheduling of a high-priority transmission (e.g., by receiving a scheduling signal from wireless network 120 via apparatus 220 as network node 125). Additionally, processor 212 may determine whether the high-priority transmission overlaps with a low-priority transmission. Moreover, processor 212 may determine to ignore a scheduling of the low-priority transmission, in an event that a scheduling of the low-priority transmission is detected, responsive to determining that the high-priority transmission overlaps with the low-priority transmission.

In some implementations, the high-priority transmission may include a high-priority PUCCH transmission, and the low-priority transmission may include a low-priority PUCCH transmission. In such cases, in determining whether the high-priority transmission overlaps with the low-priority transmission, processor 212 may determine whether a last symbol of a first PDCCH for the low-priority PUCCH transmission is not before a last symbol of a second PDCCH for the high-priority PUCCH transmission.

In some implementations, the high-priority transmission may include a high-priority DG-PUSCH transmission, and the low-priority transmission may include a low- priority DG-PUSCH transmission. In such cases, in determining whether the high-priority transmission overlaps with the low-priority transmission, processor 212 may determine whether a last symbol of a first PDCCH for the low-priority DG-PUSCH transmission is not before a last symbol of a second PDCCH for the high-priority DG-PUSCH transmission.

In some implementations, processor 212 may perform additional operations. For instance, processor 212 may detect, via transceiver 216, the scheduling of the high-priority transmission. Moreover, processor 212 may refrain from performing the low-priority transmission responsive to determining that the high-priority transmission overlaps with the low-priority transmission.

Under another proposed scheme pertaining to intra-UE prioritization in wireless communications in accordance with the present disclosure, with communication apparatus 210 implemented in or as UE 110 and network apparatus 220 implemented in or as network node 125 in network environment 100, processor 212 of communication apparatus 210 may perform, via transceiver 216, a CG-PUSCH initial transmission to a wireless network (e.g., wireless network 120 via apparatus 220 as network node 125). Additionally, processor 212 may determine a priority based on one or more signals from the wireless network. Moreover, processor 212 may perform, via transceiver 216, a CG-PUSCH retransmission to the wireless network with the determined priority.

In some implementations, in determining the priority, processor 212 may, in an event that a priority indicator is not configured in any of previously received UL scheduling DCI signals from the wireless network, determine the priority to be a priority of the CG-PUSCH initial transmission of a same CG configuration by: (a) determining the priority based on a RRC parameter phy-Prioritylndex in ConfiguredGrantConfig in an event that the CG-PUSCH retransmission is scheduled by a DCI format 0_1 or a DCI format 0_2; or (b) determining the priority to be a low priority in an event that the CG-PUSCH retransmission is scheduled by a DCI format 0_0.

In some implementations, in determining the priority, processor 212 may select a configured priority in a CG configuration from a plurality active CG configurations in an event that the apparatus is configured with the plurality of active CG configurations, with the CG configuration being associated with the CG-PUSCH retransmission.

In some implementations, in determining the priority, processor 212 may determine the priority to be a low priority regardless of a configured priority in a CG configuration in an event that a priority indicator is not configured in any of previously received UL scheduling DCI signals from the wireless network.

In some implementations, in determining the priority, processor 212 may, in an event that the CG-PUSCH retransmission is scheduled with a DCI signal from the wireless network that is not configured with a priority indicator, determine the priority to be a priority of the CG-PUSCH initial transmission of a same CG configuration by: (a) determining the priority based on a RRC parameter phy-PriorityIndex in ConfiguredGrantConfig in an event that the CG-PUSCH retransmission is scheduled with a DCI signal that is not configured with a priority indicator; or (b) determining the priority to be a low priority in an event that the CG-PUSCH retransmission is scheduled by a DCI format 0_0.

In some implementations, in determining the priority, processor 212 may determine the priority to be a priority indicated in a DCI signal from the wireless network in an event that the CG-PUSCH retransmission is scheduled with the DCI that is configured with a priority indicator.

In some implementations, in determining the priority, processor 212 may determine that the priority is not configured with a RRC parameter phy-Prioritylndex in ConfiguredGrantConfig in an event that the apparatus is not configured with a priority indicator in any of previously received UL scheduling DCI signals from the wireless network.

Under yet another proposed scheme pertaining to intra-UE prioritization in wireless communications in accordance with the present disclosure, with communication apparatus 210 implemented in or as UE 110 and network apparatus 220 implemented in or as network node 125 in network environment 100, processor 212 of communication apparatus 210 may perform, via transceiver 216, a SPS-PDSCH initial transmission to a wireless network (e.g., wireless network 120 via apparatus 220 as network node 125). Additionally, processor 212 may determine a priority based on one or more signals from the wireless network. Moreover, processor 212 may perform, via transceiver 216, a SPS-PDSCH retransmission to the wireless network with the determined priority.

In some implementations, in determining the priority, processor 212 may, in an event that a priority indicator is not configured in any of previously received DL scheduling DCI signals from the wireless network, determine the priority to be a priority of the SPS-PDSCH initial transmission of a same SPS configuration by: (a) determining a priority of a HARQ feedback for the SPS-PDSCH retransmission based on a RRC parameter harq-CodebookID in a SPS-PDSCH configuration in an event that the SPS-PDSCH retransmission is scheduled by a DCI format 1_1 or a DCI format 1_2; or (b) determining the priority of the HARQ feedback for the SPS-PDSCH retransmission to be a low priority in an event that the SPS-PDSCH retransmission is scheduled by a DCI format 1_0.

In some implementations, in determining the priority, processor 212 may select a configured priority in a SPS configuration from a plurality active SPS configurations in an event that the apparatus is configured with the plurality of active SPS configurations, with the SPS configuration being associated with the SPS-PDSCH retransmission.

In some implementations, in determining the priority, processor 212 may determine the priority to be a low priority regardless of a configured priority in a SPS configuration in an event that a priority indicator is not configured in any of previously received DL scheduling DCI signals from the wireless network.

In some implementations, in determining the priority, processor 212 may, in an event that the SPS-PDSCH retransmission is scheduled with a DCI signal from the wireless network that is not configured with a priority indicator, determine the priority to be a priority of the SPS-PDSCH initial transmission of a same SPS configuration by: (a) determining the priority based on a RRC parameter harq-CodebookID in a SPS PDSCH configuration in an event that the SPS-PDSCH retransmission is scheduled with a DCI signal that is not configured with a priority indicator; or (b) determining the priority to be a low priority in an event that the SPS-PDSCH retransmission is scheduled by a DCI format 1_0.

In some implementations, in determining the priority, processor 212 may determine a priority of a HARQ feedback for the SPS-PDSCH retransmission to be a priority indicated in a DCI signal from the wireless network in an event that the SPS-PDSCH retransmission is scheduled with the DCI that is configured with a priority indicator.

In some implementations, in determining the priority, processor 212 may determine that the priority is not configured with two HARQ-ACK codebooks in an event that the apparatus is not configured with a priority indicator in any of previously received DL scheduling DCI signals from the wireless network.

### Illustrative Processes

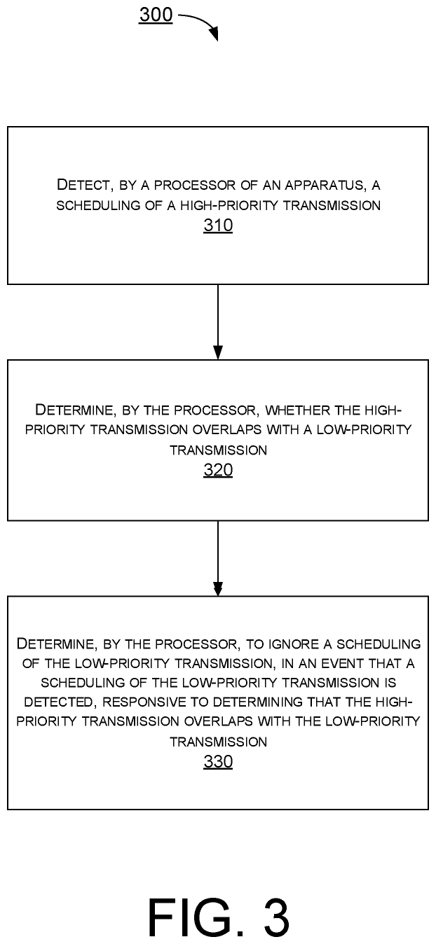

FIG. 3 illustrates an example process 300 in accordance with an implementation of the present disclosure. Process 300 may be an example implementation of schemes described above, whether partially or completely, with respect to intra-UE prioritization in wireless communications in accordance with the present disclosure. Process 300 may represent an aspect of implementation of features of communication apparatus 210. Process 300 may include one or more operations, actions, or functions as illustrated by one or more of blocks 310, 320 and 330. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices. Solely for illustrative purposes and without limitation, process 300 is described below in the context of communication apparatus 210 and network apparatus 220. Process 300 may begin at block 310.

At 310, process 300 may involve processor 212 of communication apparatus 210 detecting, via transceiver 216, a scheduling of a high-priority transmission (e.g., by receiving a scheduling signal from wireless network 120 via apparatus 220 as network node 125). Process 300 may proceed from 310 to 320.

At 320, process 300 may involve processor 212 determining whether the high-priority transmission overlaps with a low-priority transmission. Process 300 may proceed from 320 to 330.

At 330, process 300 may involve processor 212 determining to ignore a scheduling of the low-priority transmission, in an event that a scheduling of the low-priority transmission is detected, responsive to determining that the high-priority transmission overlaps with the low-priority transmission.

In some implementations, the high-priority transmission may include a high-priority PUCCH transmission, and the low-priority transmission may include a low-priority PUCCH transmission. In such cases, in determining whether the high-priority transmission overlaps with the low-priority transmission, process 300 may involve processor 212 determining whether a last symbol of a first PDCCH for the low-priority PUCCH transmission is not before a last symbol of a second PDCCH for the high-priority PUCCH transmission.

In some implementations, the high-priority transmission may include a high-priority DG-PUSCH transmission, and the low-priority transmission may include a low-priority DG-PUSCH transmission. In such cases, in determining whether the high-priority transmission overlaps with the low-priority transmission, process 300 may involve processor 212 determining whether a last symbol of a first PDCCH for the low-priority DG-PUSCH transmission is not before a last symbol of a second PDCCH for the high-priority DG-PUSCH transmission.

In some implementations, process 300 may involve processor 212 performing additional operations. For instance, process 300 may involve processor 212 detecting, via transceiver 216, the scheduling of the high-priority transmission. Moreover, process 300 may involve processor 212 refraining from performing the low-priority transmission responsive to determining that the high-priority transmission overlaps with the low-priority transmission.

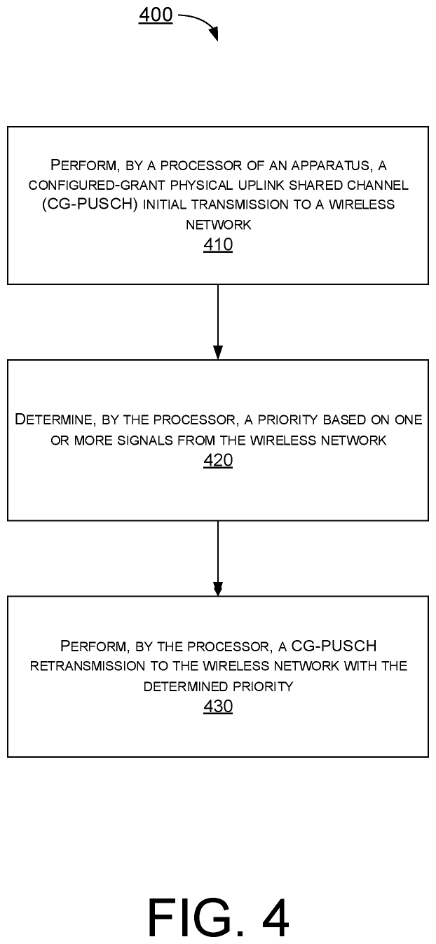

FIG. 4 illustrates an example process 400 in accordance with an implementation of the present disclosure. Process 400 may be an example implementation of schemes described above, whether partially or completely, with respect to intra-UE prioritization in wireless communications in accordance with the present disclosure. Process 400 may represent an aspect of implementation of features of communication apparatus 210. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 210 or any suitable UE or machine type devices. Solely for illustrative purposes and without limitation, process 400 is described below in the context of communication apparatus 210 and network apparatus 220. Process 400 may begin at block 410.

At 410, process 400 may involve processor 212 of communication apparatus 210 performing, via transceiver 216, a CG-PUSCH initial transmission to a wireless network (e.g., wireless network 120 via apparatus 220 as network node 125). Process 400 may proceed from 410 to 420.

At 420, process 400 may involve processor 212 determining a priority based on one or more signals from the wireless network. Process 400 may proceed from 420 to 430.

At 430, process 400 may involve processor 212 performing, via transceiver 216, a CG-PUSCH retransmission to the wireless network with the determined priority.

In some implementations, in determining the priority, process 400 may involve processor 212, in an event that a priority indicator is not configured in any of previously received UL scheduling DCI signals from the wireless network, determining the priority to be a priority of the CG-PUSCH initial transmission of a same CG configuration by: (a) determining the priority based on a RRC parameter phy-Prioritylndex in ConfiguredGrantConfig in an event that the CG-PUSCH retransmission is scheduled by a DCI format 0_1 or a DCI format 0_2; or (b) determining the priority to be a low priority in an event that the CG-PUSCH retransmission is scheduled by a DCI format 0_0.

In some implementations, in determining the priority, process 400 may involve processor 212 selecting a configured priority in a CG configuration from a plurality active CG configurations in an event that the apparatus is configured with the plurality of active CG configurations, with the CG configuration being associated with the CG-PUSCH retransmission.

In some implementations, in determining the priority, process 400 may involve processor 212 determining the priority to be a low priority regardless of a configured priority in a CG configuration in an event that a priority indicator is not configured in any of previously received UL scheduling DCI signals from the wireless network.

In some implementations, in determining the priority, process 400 may involve processor 212, in an event that the CG-PUSCH retransmission is scheduled with a DCI signal from the wireless network that is not configured with a priority indicator, determining the priority to be a priority of the CG-PUSCH initial transmission of a same CG configuration by: (a) determining the priority based on a RRC parameter phy-Prioritylndex in ConfiguredGrantConfig in an event that the CG-PUSCH retransmission is scheduled with a DCI signal that is not configured with a priority indicator; or (b) determining the priority to be a low priority in an event that the CG-PUSCH retransmission is scheduled by a DCI format 0_0.

In some implementations, in determining the priority, process 400 may involve processor 212 determining the priority to be a priority indicated in a DCI signal from the wireless network in an event that the CG-PUSCH retransmission is scheduled with the DCI that is configured with a priority indicator.

In some implementations, in determining the priority, process 400 may involve processor 212 determining that the priority is not configured with a RRC parameter phy-PriorityIndex in ConfiguredGrantConfig in an event that the apparatus is not configured with a priority indicator in any of previously received UL scheduling DCI signals from the wireless network.

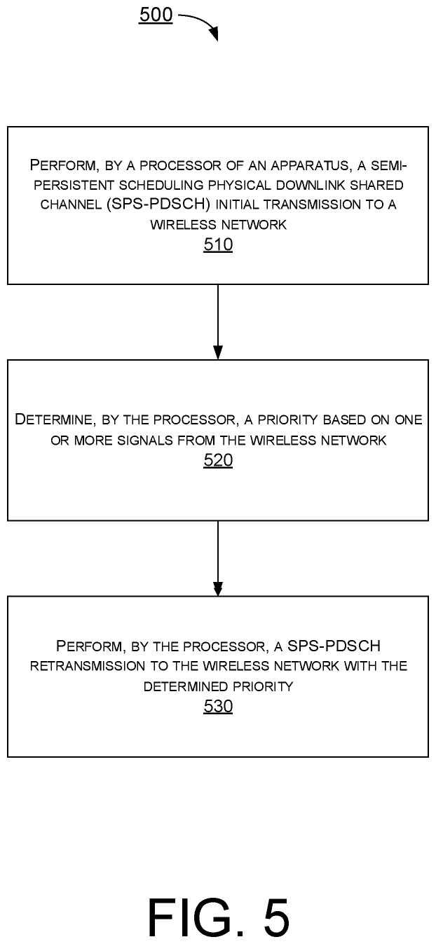

FIG. 5 illustrates an example process 500 in accordance with an implementation of the present disclosure. Process 500 may be an example implementation of schemes described above, whether partially or completely, with respect to intra-UE prioritization in wireless communications in accordance with the present disclosure. Process 500 may represent an aspect of implementation of features of communication apparatus 210. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 210 or any suitable UE or machine type devices. Solely for illustrative purposes and without limitation, process 500 is described below in the context of communication apparatus 210 and network apparatus 220. Process 500 may begin at block 510.

At 510, process 500 may involve processor 212 of communication apparatus 210 performing, via transceiver 216, a SPS-PDSCH initial transmission to a wireless network (e.g., wireless network 120 via apparatus 220 as network node 125). Process 500 may proceed from 510 to 520.

At 520, process 500 may involve processor 212 determining a priority based on one or more signals from the wireless network. Process 500 may proceed from 520 to 530.

At 530, process 500 may involve processor 212 performing, via transceiver 216, a SPS-PDSCH retransmission to the wireless network with the determined priority.

In some implementations, in determining the priority, process 500 may involve processor 212, in an event that a priority indicator is not configured in any of previously received DL scheduling DCI signals from the wireless network, determining the priority to be a priority of the SPS-PDSCH initial transmission of a same SPS configuration by: (a) determining a priority of a HARQ feedback for the SPS-PDSCH retransmission based on a RRC parameter harq-CodebookID in a SPS-PDSCH configuration in an event that the SPS-PDSCH retransmission is scheduled by a DCI format 1_1 or a DCI format 1_2; or (b) determining the priority of the HARQ feedback for the SPS-PDSCH retransmission to be a low priority in an event that the SPS-PDSCH retransmission is scheduled by a DCI format 1_0.

In some implementations, in determining the priority, process 500 may involve processor 212 selecting a configured priority in a SPS configuration from a plurality active SPS configurations in an event that the apparatus is configured with the plurality of active SPS configurations, with the SPS configuration being associated with the SPS-PDSCH retransmission.

In some implementations, in determining the priority, process 500 may involve processor 212 determining the priority to be a low priority regardless of a configured priority in a SPS configuration in an event that a priority indicator is not configured in any of previously received DL scheduling DCI signals from the wireless network.

In some implementations, in determining the priority, process 500 may involve processor 212, in an event that the SPS-PDSCH retransmission is scheduled with a DCI signal from the wireless network that is not configured with a priority indicator, determining the priority to be a priority of the SPS-PDSCH initial transmission of a same SPS configuration by: (a) determining the priority based on a RRC parameter harq-CodebookID in a SPS PDSCH configuration in an event that the SPS-PDSCH retransmission is scheduled with a DCI signal that is not configured with a priority indicator; or (b) determining the priority to be a low priority in an event that the SPS-PDSCH retransmission is scheduled by a DCI format 1_0.

In some implementations, in determining the priority, process 500 may involve processor 212 determining a priority of a HARQ feedback for the SPS-PDSCH retransmission to be a priority indicated in a DCI signal from the wireless network in an event that the SPS-PDSCH retransmission is scheduled with the DCI that is configured with a priority indicator.

In some implementations, in determining the priority, process 500 may involve processor 212 determining that the priority is not configured with two HARQ-ACK codebooks in an event that the apparatus is not configured with a priority indicator in any of previously received DL scheduling DCI signals from the wireless network. Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
detecting, by a processor of an apparatus, a scheduling of a high-priority transmission;
determining, by the processor, whether the high-priority transmission overlaps with a low-priority transmission; and
determining, by the processor, to ignore a scheduling of the low-priority transmission, in an event that a scheduling of the low-priority transmission is detected, responsive to determining that the high-priority transmission overlaps with the low-priority transmission.

2. The method of claim 1, wherein the high-priority transmission comprises a high-priority physical uplink control channel (PUCCH) transmission, and wherein the low-priority transmission comprises a low-priority PUCCH transmission.

3. The method of claim 2, wherein the determining of whether the high-priority transmission overlaps with the low-priority transmission comprises determining whether a last symbol of a first physical downlink control channel (PDCCH) for the low-priority PUCCH transmission is not before a last symbol of a second PDCCH for the high-priority PUCCH transmission.

4. The method of claim 1, wherein the high-priority transmission comprises a high-priority dynamic-grant physical uplink shared channel (DG-PUSCH) transmission, and wherein the low-priority transmission comprises a low-priority DG-PUSCH transmission.

5. The method of claim 4, wherein the determining of whether the high-priority transmission overlaps with the low-priority transmission comprises determining whether a last symbol of a first physical downlink control channel (PDCCH) for the low-priority DG-PUSCH transmission is not before a last symbol of a second PDCCH for the high-priority DG-PUSCH transmission.

6. The method of claim 1, further comprising:
detecting, by the processor, the scheduling of the high-priority transmission; and
refraining, by the processor, from performing the low-priority transmission responsive to determining that the high-priority transmission overlaps with the low-priority transmission.

7. A method, comprising:
performing, by a processor of an apparatus, a configured-grant physical uplink shared channel (CG-PUSCH) initial transmission to a wireless network;
determining, by the processor, a priority based on one or more signals from the wireless network; and
performing, by the processor, a CG-PUSCH retransmission to the wireless network with the determined priority.

7. The method of claim 7, wherein the determining of the priority comprises, in an event that a priority indicator is not configured in any of previously received uplink (UL) scheduling downlink control information (DCI) signals from the wireless network, determining the priority to be a priority of the CG-PUSCH initial transmission of a same configured-grant (CG) configuration by:
determining the priority based on a radio resource control (RRC) parameter phy-PriorityIndex in ConfiguredGrantConfig in an event that the CG-PUSCH retransmission is scheduled by a DCI format 0_1 or a DCI format 0_2; or
determining the priority to be a low priority in an event that the CG-PUSCH retransmission is scheduled by a DCI format 0_0.

9. The method of claim 7, wherein the determining of the priority comprises selecting a configured priority in a configured-grant (CG) configuration from a plurality active CG configurations in an event that the apparatus is configured with the plurality of active CG configurations, wherein the CG configuration is associated with the CG-PUSCH retransmission.

10. The method of claim 7, wherein the determining of the priority comprises determining the priority to be a low priority regardless of a configured priority in a configured-grant (CG) configuration in an event that a priority indicator is not configured in any of previously received uplink (UL) scheduling downlink control information (DCI) signals from the wireless network.

11. The method of claim 7, wherein the determining of the priority comprises, in an event that the CG-PUSCH retransmission is scheduled with a downlink control information (DCI) signal from the wireless network that is not configured with a priority indicator, determining the priority to be a priority of the CG-PUSCH initial transmission of a same configured-grant (CG) configuration by:
determining the priority based on a radio resource control (RRC) parameter phy-PriorityIndex in ConfiguredGrantConfig in an event that the CG-PUSCH retransmission is scheduled with a DCI signal that is not configured with a priority indicator; or
determining the priority to be a low priority in an event that the CG-PUSCH retransmission is scheduled by a DCI format 0_0.

12. The method of claim 7, wherein the determining of the priority comprises determining the priority to be a priority indicated in a downlink control information (DCI) signal from the wireless network in an event that the CG-PUSCH retransmission is scheduled with the DCI that is configured with a priority indicator.

13. The method of claim 7, wherein the determining of the priority comprises determining that the priority is not configured with a radio resource control (RRC) parameter phy-PriorityIndex in ConfiguredGrantConfig in an event that the apparatus is not configured with a priority indicator in any of previously received uplink (UL) scheduling downlink control information (DCI) signals from the wireless network.

14. A method, comprising:
performing, by a processor of an apparatus, a semi-persistent scheduling physical downlink shared channel (SPS-PDSCH) initial transmission to a wireless network;
determining, by the processor, a priority based on one or more signals from the wireless network; and
performing, by the processor, a SPS-PDSCH retransmission to the wireless network with the determined priority.

15. The method of claim 14, wherein the determining of the priority comprises, in an event that a priority indicator is not configured in any of previously received downlink (DL) scheduling downlink control information (DCI) signals from the wireless network, determining the priority to be a priority of the SPS-PDSCH initial transmission of a same semi-persistent (SPS) configuration by:
determining a priority of a hybrid automatic repeat request (HARQ) feedback for the SPS-PDSCH retransmission based on a radio resource control (RRC) parameter harq-CodebookID in a SPS-PDSCH configuration in an event that the SPS-PDSCH retransmission is scheduled by a DCI format 1_1 or a DCI format 1_2; or
determining the priority of the HARQ feedback for the SPS-PDSCH retransmission to be a low priority in an event that the SPS-PDSCH retransmission is scheduled by a DCI format 1_0.

16. The method of claim 14, wherein the determining of the priority comprises selecting a configured priority in a semi-persistent scheduling (SPS) configuration from a plurality active SPS configurations in an event that the apparatus is configured with the plurality of active SPS configurations, wherein the SPS configuration is associated with the SPS-PDSCH retransmission.

17. The method of claim 14, wherein the determining of the priority comprises determining the priority to be a low priority regardless of a configured priority in a semi-persistent scheduling (SPS) configuration in an event that a priority indicator is not configured in any of previously received downlink (DL) scheduling downlink control information (DCI) signals from the wireless network.

18. The method of claim 14, wherein the determining of the priority comprises, in an event that the SPS-PDSCH retransmission is scheduled with a downlink control information (DCI) signal from the wireless network that is not configured with a priority indicator, determining the priority to be a priority of the SPS-PDSCH initial transmission of a same semi-persistent scheduling (SPS) configuration by:
determining the priority based on a radio resource control (RRC) parameter harq-CodebookID in a SPS PDSCH configuration in an event that the SPS-PDSCH retransmission is scheduled with a DCI signal that is not configured with a priority indicator; or
determining the priority to be a low priority in an event that the SPS-PDSCH retransmission is scheduled by a DCI format 1_0.

19. The method of claim 14, wherein the determining of the priority comprises determining a priority of a hybrid automatic repeat request (HARQ) feedback for the SPS-PDSCH retransmission to be a priority indicated in a downlink control information (DCI) signal from the wireless network in an event that the SPS-PDSCH retransmission is scheduled with the DCI that is configured with a priority indicator.

20. The method of claim 14, wherein the determining of the priority comprises determining that the priority is not configured with two hybrid automatic repeat request acknowledgement (HARQ-ACK) codebooks in an event that the apparatus is not configured with a priority indicator in any of previously received downlink (DL) scheduling downlink control information (DCI) signals from the wireless network.
